(19) United States
(12) Patent Application Publication
(10) Pub. No.: US 2026/0140080 A1
(43) Pub. Date: May 21, 2026

(54) MOISTURE SENSOR

(71) Applicant: The Boeing Company, Arlington, VA (US)

(72) Inventors: Uddip KASHYAP, Bangalore (IN); Amar PATEL, Bangalore (IN)

(21) Appl. No.: 19/096,835

(22) Filed: Apr. 1, 2025

Related U.S. Application Data
(60) Provisional application No. 63/721,739, filed on Nov. 18, 2024.

(51) Int. Cl. G01N 27/22

(52) U.S. Cl. CPC G01N 27/223; G01N 27/227

(57) ABSTRACT

The present disclosure describes a moisture sensor system. The system includes a dielectric layer, a first metal plate, and a second metal plate. The dielectric layer includes a moisture absorbing material. The first metal plate is positioned on the dielectric layer. The second metal plate is positioned in the dielectric layer such that a first portion of the dielectric layer is positioned between the first metal plate and the second metal plate and such that the dielectric layer, the first metal plate, and the second metal plate form a capacitor. A capacitance of the capacitor changes when the moisture absorbing material absorbs a fluid.

### CROSS-REFERENCE TO RELATED APPLICATION

This Patent Application claims priority to U.S. Patent Application No. 63/721,739, filed on November 18, 2024, and entitled “MOISTURE SENSOR.” The disclosure of the prior Application is considered part of and is incorporated by reference into this Patent Application.

### FIELD

Aspects of the present disclosure relate to sensor systems (e.g., moisture sensor systems and rust sensor systems).

### BACKGROUND

Certain substances may negatively impact the proper operation of electro-mechanical systems (e.g., aeronautic systems). For example, moisture (e.g., from fluid leaks) and/or rust may cause the system to operate incorrectly or to cease functioning.

### SUMMARY

The present disclosure describes a moisture sensor system. According to an aspect, a system includes a dielectric layer, a first metal plate, and a second metal plate. The dielectric layer includes a moisture absorbing material. The first metal plate is positioned on the dielectric layer. The second metal plate is positioned in the dielectric layer such that a first portion of the dielectric layer is positioned between the first metal plate and the second metal plate and such that the dielectric layer, the first metal plate, and the second metal plate form a capacitor. A capacitance of the capacitor changes when the moisture absorbing material absorbs a fluid.

The system may include a device that measures, over a period of time, the capacitance of the capacitor a plurality of times.

The system may include a device that determines a rate of change of the capacitance of the capacitor, determines another rate of change of the rate of change of the capacitance of the capacitor, and determines a type of the fluid absorbed by the dielectric layer based on the other rate of change. The type of the fluid may include at least one of water or oil.

The moisture absorbing material may include at least one of cotton or glass fiber.

The second metal plate may be positioned on a second portion of the dielectric layer. The first portion of the dielectric layer may be coupled to the second portion of the dielectric layer. The second metal plate may define a channel through which the fluid flows from the second portion of the dielectric layer to the first portion of the dielectric layer.

The system may include an insulation layer positioned on the first metal plate.

According to another aspect, a system includes a dielectric layer and a metal plate. The dielectric layer includes a moisture absorbing material. The metal plate is positioned on the dielectric layer. When the dielectric layer is positioned on a structural member, the metal plate, the dielectric layer, and the structural member form a capacitor. A capacitance of the capacitor changes when the moisture absorbing material absorbs moisture.

The system may include a device that measures, over a period of time, the capacitance of the capacitor a plurality of times.

The system may include a device that determines a rate of change of the capacitance of the capacitor, determines another rate of change of the rate of change of the capacitance of the capacitor, and determines a type of fluid absorbed by the dielectric layer based on the other rate of change. The type of fluid may include at least one of water or oil.

The moisture absorbing material may include glass fiber.

The system may include an insulation layer positioned on the metal plate.

According to another aspect, a method includes absorbing a fluid by a dielectric layer. A first metal plate is positioned on the dielectric layer. A second metal plate is positioned in the dielectric layer such that a first portion of the dielectric layer is positioned between the first metal plate and the second metal plate and such that the dielectric layer, the first metal plate, and the second metal plate form a capacitor. The method also includes detecting a change in a capacitance of the capacitor caused by the dielectric layer absorbing the fluid and determining that the dielectric layer has absorbed the fluid based on detecting the change in the capacitance.

Detecting the change in the capacitance of the capacitor may include measuring, over a period of time, the capacitance of the capacitor a plurality of times.

The method may include determining a rate of change of the capacitance of the capacitor, determining another rate of change of the rate of change of the capacitance of the capacitor, and determining a type of the fluid absorbed by the dielectric layer based on the other rate of change. The type of the fluid may include at least one of water or oil.

The dielectric layer may include at least one of cotton or glass fiber.

The second metal plate may be positioned on a second portion of the dielectric layer. The first portion of the dielectric layer may be coupled to the second portion of the dielectric layer.

The features, functions, and advantages described herein can be achieved independently in various implementations or can be combined in other implementations, further details of which are shown in the drawings and described below.

### BRIEF DESCRIPTION OF THE DRAWINGS

So that the manner in which the above recited features can be understood in detail, a more particular description, briefly summarized above, may be had by reference to example aspects, some of which are illustrated in the appended drawings.

FIG. 1 illustrates an example system.

FIG. 2 illustrates an example device in the system of FIG. 1.

FIG. 3 illustrates an example device in the system of FIG. 1.

FIG. 4A illustrates an example sensor in the system of FIG. 1.

FIG. 4B illustrates an example sensor in the system of FIG. 1.

FIG. 4C is a flowchart of an example method performed by the system of FIG. 1.

FIG. 4D is a flowchart of an example method performed by the system of FIG. 1.

FIG. 5A illustrates an example sensor in the system of FIG. 1.

FIG. 5B is a flowchart of an example method performed by the system of FIG. 1.

### DETAILED DESCRIPTION

The following detailed description of example implementations refers to the accompanying drawings. The same reference numbers in different drawings identify the same or similar elements.

The present disclosure describes a sensor system for an electro-mechanical system, such as an aeronautical system (e.g., an aircraft). Generally, the sensor system is a capacitive sensor system that may be used to detect the presence of different substances (e.g., moisture and/or rust). The sensor system may include one or more sensors that may be attached to structural members in the electro-mechanical system (e.g., onto the surfaces of aircraft parts). When certain substances are present near the sensor, the capacitance of the sensor may change, indicating the presence of the substance.

For example, a sensor may be arranged to detect moisture. The sensor includes a capacitor with a dielectric, or the sensor may be positioned on a structural member of the electro-mechanical system such that the sensor and the structural member form a capacitor with a dielectric. When a fluid leak forms near the sensor, the dielectric in the sensor may absorb the fluid, which causes the capacitance of the capacitor to change. When the sensor system detects the change in the capacitance, the system may determine that the dielectric has absorbed the fluid and that the fluid leak is occurring.

As another example, a sensor may be arranged to detect rust. The sensor may be positioned on a structural member of the electro-mechanical system such that the sensor and the structural member form a capacitor with a dielectric. When rust forms on the structural member between the structural member and the dielectric, the capacitance of the capacitor may change. When the sensor system detects the change in the capacitance, the system may determine that rust has formed on the structural member.

In certain aspects, the sensor system provides several technical advantages. For example, the sensor system may be smaller and lighter than existing sensor systems (e.g., pressure-based systems and ultrasonic systems), which improves the operation of certain electro-mechanical systems (e.g., aeronautical systems) relative to existing sensor systems. As another example, the sensor system may be installed in locations where access to external electrical power may be challenging.

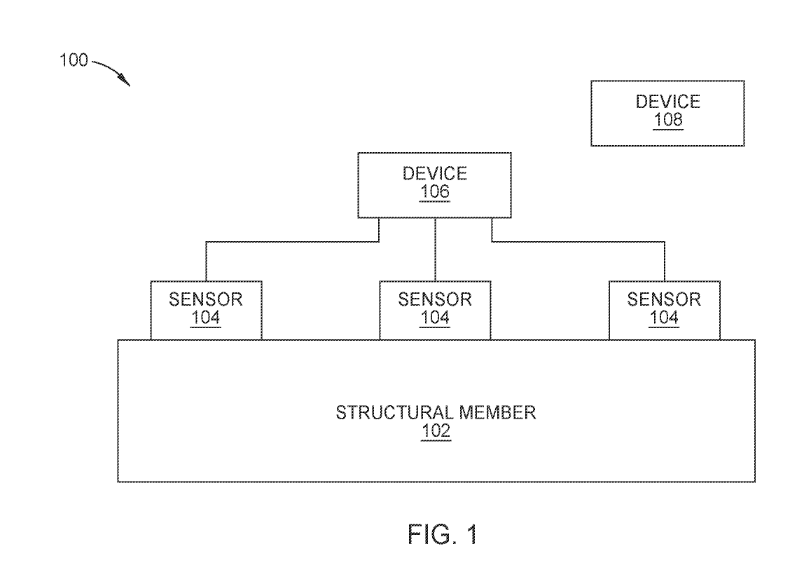

FIG. 1 illustrates an example system 100 (e.g., an aeronautical system). As seen in FIG. 1, the system 100 includes a structural member 102, one or more sensors 104, a device 106, and a device 108. Generally, the sensors 104 are attached to the structural member and may detect substances with respect to the structural member 102. For example, the sensors 104 may detect when there is a fluid leak on or in the structural member 102. As another example, the sensors 104 may detect when rust has formed on the structural member. The sensors 104 may be positioned on different portions of the structural member 102 to detect the presence of substances near those portions.

The structural member 102 may be a component in an aeronautical system. For example, the structural member 102 may be a component of an aircraft. Fluid leaks and/or rust may damage the structural member and compromise the structural integrity of the structural member 102. As a result, it may be desirable to quickly remedy or resolve fluid leaks and rust on or in the structural member 102. Due to space and weight constraints in aeronautical systems, it may be challenging to incorporate existing sensors (e.g., pressure-based sensors and ultrasonic sensors) on the structural member 102.

The sensors 104 are capacitive sensors that may be smaller and lighter than existing sensors. Generally, the sensors 104 have a capacitance that changes when the sensors 104 are in the presence of fluid or rust. Detecting the change in capacitance in the sensors 104 may reveal the presence of a fluid leak or rust. For example, a sensor 104 may include a dielectric layer that includes a material (e.g., cotton or glass fiber) that absorbs fluid. When a fluid leak occurs near the sensor 104, the dielectric layer may absorb the fluid, causing the dielectric constant of the dielectric layer to change, which changes the capacitance of the sensor 104. As another example, a sensor 104 may include a dielectric layer that is positioned on the structural member 102. When rust forms on the structural member 102, the rust is positioned between the structural member 102 and the dielectric layer, causing the capacitance of the sensor 104 to change.

The device 106 may be connected to the one or more sensors 104. Generally, the device 106 may provide electrical power to the sensors 104 and receive signals from the sensors 104. These signals may indicate the capacitances of the sensors 104, or the signals may be used to determine the capacitances of the sensors 104.

The device 108 may be a user device that connects to the device 106. The device 106 may report the signals from the sensors 104 to the device 108, and the device 108 may determine the capacitances of the sensors 104 using the signals. Alternatively or additionally, the device 106 may report the capacitances of the sensors 104 to the device 108. The device 108 may display or present the capacitances of the sensors 104 to the device 108. By reviewing the capacitances of the sensors 104 over time, the device 108 may determine whether there is a fluid leak or rust on the structural member 102.

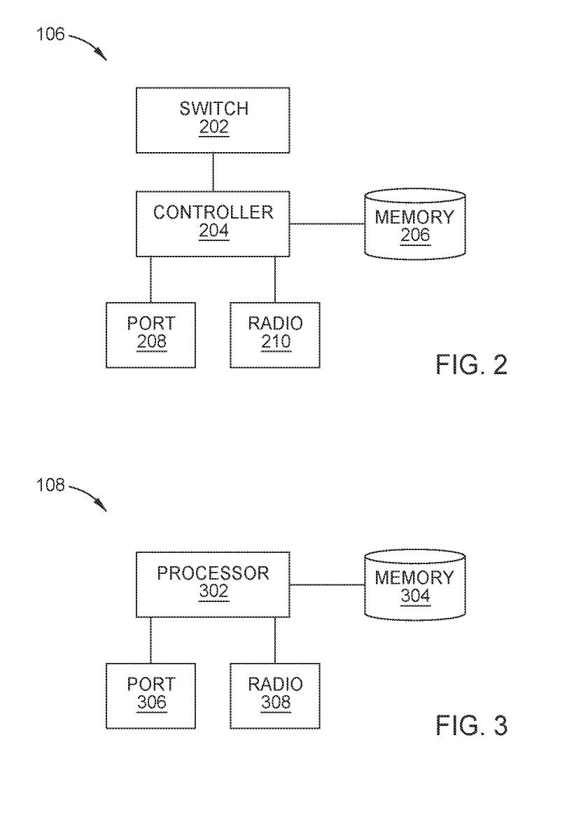

FIG. 2 illustrates an example device 106 in the system 100 of FIG. 1. As seen in FIG. 2, the device 106 includes a switch 202, a controller 204, a memory 206, a port 208, and/or a radio 210. Generally, the device 106 powers and receives signals from the sensors 104.

The switch 202 may provide connections to the sensors 104. In some instances, the switch 202 may provide power to one of the sensors 104 at a time. The powered sensor 104 may communicate signals to the switch 202 when powered. The switch 202 may then report the received signals to the controller 204. The switch 202 may then stop providing power to the sensor 104 and start providing power to another sensor 104. This process may continue as the switch 202 cycles through the sensors 104.

The controller 204 may control the switch 202 and may process the signals from the switch 202. The controller 204 may execute software code stored in the memory 206 that instruct the controller 204 how to control the switch 202 and how to process the signals from the switch 202. For example, the controller 204 may instruct the switch 202 how to cycle through the sensors 104. The controller 204 may then determine the capacitances of the sensors 104 using the signals from the switch 202. The controller 204 may be a microcontroller. In some implementations, the controller 204 includes a processor.

The processor is any electronic circuitry, including, but not limited to one or a combination of microprocessors, microcontrollers, application specific integrated circuits (ASIC), application specific instruction set processor (ASIP), and/or state machines, that communicatively couples to the memory 206 and controls the operation of the device 106. The processor may be 8-bit, 16-bit, 32-bit, 64-bit or of any other suitable architecture. The processor may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor may include other hardware that operates software to control and process information. The processor executes software stored on the memory 206 to perform any of the functions described herein. The processor controls the operation and administration of the device 106 by processing information (e.g., information received from the sensors 104, device 108, and memory 206). The processor is not limited to a single processing device and may encompass multiple processing devices contained in the same device or computer or distributed across multiple devices or computers. The processor is considered to perform a set of functions or actions if the multiple processing devices collectively perform the set of functions or actions, even if different processing devices perform different functions or actions in the set.

The memory 206 may store, either permanently or temporarily, data, operational software, or other information for the controller 204. The memory 206 may include any one or a combination of volatile or non-volatile local or remote devices suitable for storing information. For example, the memory 206 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 206, a disk, a CD, or a flash drive. In particular embodiments, the software may include an application executable by the controller 204 to perform one or more of the functions described herein. The memory 206 is not limited to a single memory and may encompass multiple memories contained in the same device or computer or distributed across multiple devices or computers. The memory 206 is considered to store a set of data, operational software, or information if the multiple memories collectively store the set of data, operational software, or information, even if different memories store different portions of the data, operational software, or information in the set.

The device 106 connects to the device 108 through the port 208 and/or the radio 210. The port 208 may be a hardware port that allows for physical or wired connections with the device 108. The radio 210 may be a wireless radio that allows for wireless connections or communications with the device 108. After a connection is formed with the device 108 through the port 208 or the radio 210, the device 106 may communicate signals (e.g., signals indicating the capacitances of the sensors 104 or signals that can be used to determine the capacitances of the sensors 104) to the device 108 through the connection.

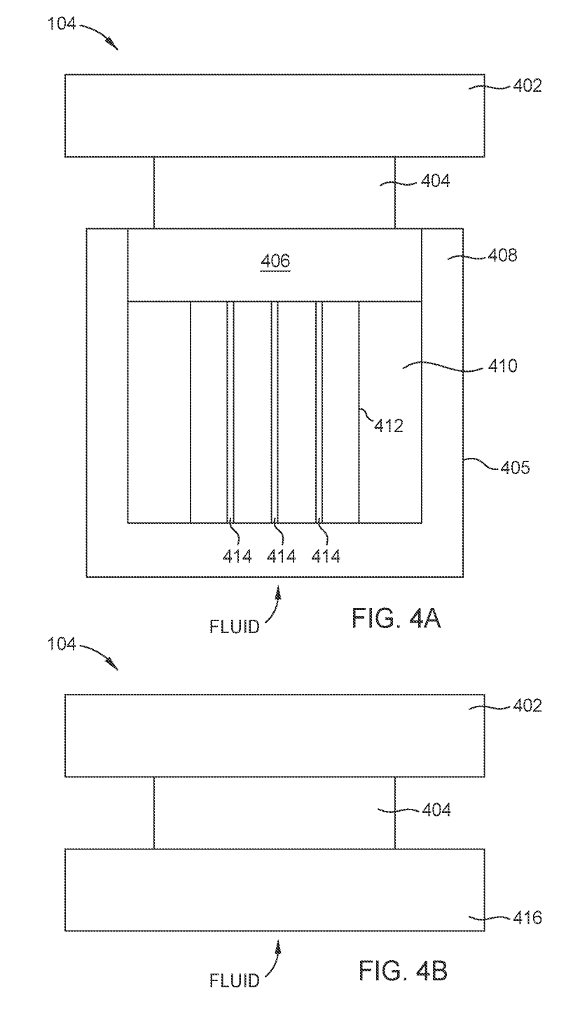

FIG. 3 illustrates an example device 108 in the system 100 of FIG. 1. As seen in FIG. 3, the device 108 includes a processor 302, a memory 304, a port 306, and a radio 308. Generally, a user may connect the device 108 to the device 106 to receive signals from the device 106. The device 108 may determine the capacitances of the sensors 104 from these signals. The changes in these capacitances over time may indicate whether the sensors 104 have detected a substance (e.g., a fluid leak or rust).

The device 108 is any suitable device for communicating with components of the system 100 (e.g., the device 106). As an example and not by way of limitation, the device 108 may be a computer, a laptop, a wireless or cellular telephone, an electronic notebook, a personal digital assistant, a tablet, or any other device capable of receiving, processing, storing, or communicating information with other components of the system 100. The device 108 may be a wearable device such as a virtual reality or augmented reality headset, a smart watch, or smart glasses. The device 108 may also include a user interface, such as a display, a microphone, keypad, or other appropriate terminal equipment. The device 108 may include a hardware processor, memory, or circuitry configured to perform any of the functions or actions of the device 108 described herein. For example, a software application designed using software code may be stored in the memory and executed by the processor to perform the functions of the device 108.

The processor 302 is any electronic circuitry, including, but not limited to one or a combination of microprocessors, microcontrollers, ASICs, ASIPs, and/or state machines, that communicatively couples to the memory 304 and controls the operation of the device 108. The processor 302 may be 8-bit, 16-bit, 32-bit, 64-bit or of any other suitable architecture. The processor 302 may include an ALU for performing arithmetic and logic operations, processor registers that supply operands to the ALU and store the results of ALU operations, and a control unit that fetches instructions from memory and executes them by directing the coordinated operations of the ALU, registers and other components. The processor 302 may include other hardware that operates software to control and process information. The processor 302 executes software stored on the memory 304 to perform any of the functions described herein. The processor 302 controls the operation and administration of the device 108 by processing information (e.g., information received from the device 106, sensors 104, and memory 304). The processor 302 is not limited to a single processing device and may encompass multiple processing devices contained in the same device or computer or distributed across multiple devices or computers. The processor 302 is considered to perform a set of functions or actions if the multiple processing devices collectively perform the set of functions or actions, even if different processing devices perform different functions or actions in the set.

The memory 304 may store, either permanently or temporarily, data, operational software, or other information for the processor 302. The memory 304 may include any one or a combination of volatile or non-volatile local or remote devices suitable for storing information. For example, the memory 304 may include RAM, ROM, magnetic storage devices, optical storage devices, or any other suitable information storage device or a combination of these devices. The software represents any suitable set of instructions, logic, or code embodied in a computer-readable storage medium. For example, the software may be embodied in the memory 304, a disk, a CD, or a flash drive. In particular embodiments, the software may include an application executable by the processor 302 to perform one or more of the functions described herein. The memory 304 is not limited to a single memory and may encompass multiple memories contained in the same device or computer or distributed across multiple devices or computers. The memory 304 is considered to store a set of data, operational software, or information if the multiple memories collectively store the set of data, operational software, or information, even if different memories store different portions of the data, operational software, or information in the set.

The device 108 may connect to the device 106 using the port 306 and/or the radio 308. For example, the device 108 may use the port 306 to form a physical or wired connection with the 208 of the device 106. As another example, the device 108 may use the radio 308 to form a wireless connection with the radio 210 of the device 106. After forming the connection, the device 108 may receive signals from the device 106 using the connection. These signals may indicate capacitances of the sensors 104 and whether the sensors 104 have detected a substance (e.g., a fluid leak or rust).

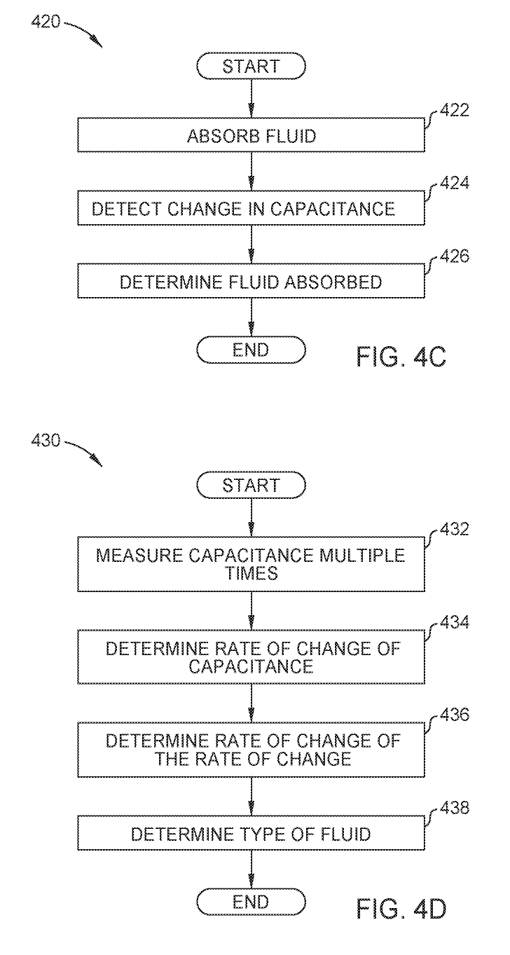

FIG. 4A illustrates an example sensor 104 in the system 100 of FIG. 1. As seen in FIG. 4A, the sensor 104 includes a layer 402, a metal layer 404, a dielectric layer 405, and a metal layer 412. Generally, the metal layer 404, the dielectric layer 405, and the metal layer 412 form a capacitor. The capacitance of the capacitor may change when a fluid leak occurs near the sensor 104.

The layer 402 may be positioned above the metal layer 404, the dielectric layer 405, and the metal layer 412. Generally, the layer 402 may be an insulation layer that is formed from an electrically insulated material. As a result, the layer 402 may insulate a top portion of the capacitor in the sensor 104.

The metal layer 404 may be formed using any electrically conducting material (e.g., aluminum). The layer 402 is positioned on the metal layer 404, and the metal layer 404 is positioned on the dielectric layer 405. In some implementations, the metal layer 404 may be formed as a first metal plate (e.g., a first metal plate 404).

The dielectric layer 405 is formed using a material that absorbs moisture and/or fluid. For example, the dielectric layer 405 may be formed using cotton or glass fiber (e.g., at least one of cotton or glass fiber). As seen in FIG. 4A, the dielectric layer 405 includes a portion 406 and a portion 408. The metal layer 404 is positioned on the portion 406. The portion 408 couples to the sides of the portion 406. Additionally, the portion 408 extends downwards past the metal layer 412. The portion 408 may be positioned on and contact the structural member 102 when the sensor 104 is positioned on the structural member 102.

Additionally, the portion 406 and the portion 408 may be shaped such that the dielectric layer 405 defines a cavity 410. The metal layer 412 is positioned within the cavity 410. For example, the metal layer 412 may be positioned within the cavity 410 such that the metal layer 412 is positioned on the portion 406 and is positioned on the portion 408. In some implementations, the metal layer 412 may be formed as a second metal plate (e.g., a second metal plate 412). The portion 406 may be positioned on the metal layer 412 such that the portion 406 is positioned between the metal layer 404 and the metal layer 412. The metal layer 412 may be formed using any electrically conductive material (e.g., aluminum). As a result, the metal layer 404, the dielectric layer 405, and the metal layer 412 form a capacitor.

When a fluid leak occurs on or in the structural member 102, the fluid may flow near the sensor 104. Because the dielectric layer 405 positioned on the structural member 102 includes a material that absorbs moisture and/or fluids, the dielectric layer 405 may absorb the fluid flowing near the sensor 104. The fluid may enter the dielectric layer 405 through the portion 408. The fluid may travel through the portion 408 and into the portion 406 between the metal layer 404 and the metal layer 412. When the dielectric layer 405 absorbs the fluid, the dielectric constant of the dielectric layer 405 changes, causing the capacitance of the capacitor to change. Thus, detecting the change in capacitance of the capacitor may reveal the presence of the fluid leak.

In some implementations, the metal layer 412 defines channels 414 through the metal layer 412. Some of the fluid absorbed by the portion 408 may flow through the channels 414 and into the portion 406. In this manner, the structure of the metal layer 412 helps the fluid absorbed by the portion 408 to flow towards the portion 406. As a result, the channels 414 may allow a fluid leak to be detected more quickly.

FIG. 4B illustrates an example sensor 104 in the system 100 of FIG. 1. As seen in FIG. 4B, the sensor 104 includes the layer 402, the metal layer 404, and a dielectric layer 416. The layer 402 is positioned on the metal layer 404. In some implementations, the metal layer 404 may be formed as a metal plate (e.g., a metal plate 404). The metal layer 404 is positioned on the dielectric layer 416. As a result, the metal layer 404 is positioned between the layer 402 and the dielectric layer 416. When the sensor 104 is positioned on the structural member 102, the dielectric layer 416 may be positioned on the structural member 102 and may contact the structural member 102. The metal layer 404, the dielectric layer 416, and the structural member 102 form a capacitor.

The dielectric layer 416 may include a material that absorbs moisture or fluid (e.g., cotton or glass fiber). When a fluid leak occurs on or in the structural member 102, the fluid may flow near the dielectric layer 416. The dielectric layer 416 may absorb the fluid, which changes the dielectric constant of the dielectric layer 416, causing the capacitance of the capacitor to change. Thus, by monitoring the capacitance and detecting changes in the capacitance, the fluid leak may be detected.

In some implementations, the system 100 determines the type of fluid that the sensor 104 has absorbed by tracking how the capacitance of the capacitor formed by the sensor 104 changes. For example, the device 106 and/or the device 108 may measure or determine the capacitance of the capacitor over time. As the dielectric layer 405 or the dielectric layer 416 absorb fluid, the capacitance gradually changes until the dielectric layer 405 or the dielectric layer 416 is saturated. When the dielectric layer 405 or the dielectric layer 416 is saturated, it may be difficult for the dielectric layer 405 or the dielectric layer 416 to absorb additional fluid. As a result, the capacitance of the capacitor stabilizes. By monitoring how quickly or slowly the capacitance of the capacitor changes, the system 100 may determine the type of fluid that the sensor 104 absorbed.

For example, the device 106 and/or the device 108 may determine a rate of increase for the capacitance of the capacitor over time. If the capacitance of the capacitor is plotted over time, the rate of increase may be the slope of the plot at different points in time or a first derivative of the plot. The device 106 and/or the device 108 may then determine a rate of change of the rate of increase over time. The rate of change of the rate of increase may be the slope of the plot of the rate of increase at different points in time or a second derivative of the plot of capacitance over time. The device 106 and/or the device 108 may then determine the type of fluid absorbed by the sensor 104 by using the rate of change of the rate of increase of the capacitance. For example, the device 106 and/or the device 108 may determine a time average of the rate of change of the rate of increase of the capacitance. The device 106 and/or the device 108 may then determine the type of fluid using the time average.

Generally, different types of fluid will cause different rates of change of the rates of increase of the capacitance when the types of fluid are absorbed by the sensor 104. For example, when water is absorbed by the sensor 104, the average rate of change of the rate of increase of the capacitance may exceed 50 picoFarads (pF) per second squared (pF/s²). When brake oil is absorbed by the sensor 104, the average rate of change of the rate of increase of the capacitance may be around 1.3 pF/s². When diesel is absorbed by the sensor 104, the average rate of change of the rate of increase of the capacitance may be around 3 pF/s². The 106 and/or the device 108 may compare the determined average rate of change of the rate of increase of the capacitance to values in a table to determine the type of fluid absorbed by the sensor 104.

FIG. 4C is a flowchart of an example method 420 performed by the system 100 of FIG. 1. Different components of the system 100 perform the steps of the method 420. By performing the method 420, the system 100 may detect fluid leaks.

In 422, the sensor 104 absorbs a fluid. The sensor 104 may include a dielectric layer 405 or dielectric layer 416 positioned on a structural member 102 (e.g., a component or part of an aeronautical system). The dielectric layer 405 or dielectric layer 416 may be part of a capacitor formed by the sensor 104 and/or the structural member 102. The dielectric layer 405 or dielectric layer 416 may include a material that absorbs moisture or fluid (e.g., cotton or glass fiber). When a fluid leak occurs on or in the structural member 102, fluid may flow near the sensor 104. The dielectric layer 405 or dielectric layer 416 may absorb the fluid, changing the dielectric constant of the dielectric layer 405 or dielectric layer 416, which causes the capacitance of the capacitor to change.

In 424, the device 106 and/or the device 108 detects a change in the capacitance of the capacitor. For example, the device 106 and/or the device 108 may power the sensor 104, and the sensor 104 may communicate signals to the device 106 and/or the device 108. These signals may indicate the capacitance of the capacitor, or these signals may be used by the device 106 and/or the device 108 to determine the capacitance of the capacitor. The device 106 and/or the device 108 may measure the capacitance of the capacitor over time to determine whether the capacitance changes over time.

In 426, the device 106 and/or the device 108 determines that a fluid has been absorbed by the sensor 104, which indicates that fluid leak is occurring. The device 106 and/or the device 108 may determine that the sensor 104 has absorbed fluid if the capacitance of the capacitor changes. For example, the device 106 and/or the device 108 may compare the measurements of the capacitance over time with a baseline or original capacitance of the capacitor to determine a difference. If the difference ever exceeds a threshold, then the device 106 and/or the device 108 may determine that the sensor 104 has absorbed fluid and/or that a fluid leak is occurring.

FIG. 4D is a flowchart of an example method 430 performed by the system 100 of FIG. 1. Different components of the system 100 perform the steps of the method 430. By performing the method 430, the system 100 determines a type of fluid absorbed by the sensor 104.

In 432, the device 106 and/or the device 108 measure the capacitance of the capacitor multiple times. The device 106 and/or the device 108 may measure the capacitance of the capacitor periodically or regularly over a period of time (e.g., may measure the capacitance of the capacitor a plurality of times over the period of time). In 434, the device 106 and/or the device 108 determines, from these measurements of the capacitance, a rate of change of the capacitance over time. In 436, the device 106 and/or the device 108 determines a rate of change of the rate of change (e.g., another rate of change of the rate of change) of the capacitance over time. Effectively, the device 106 and/or the device 108 determines a second derivative of the capacitance over time.

In 438, the device 106 and/or the device 108 determines the type of fluid absorbed by the sensor 104 using the rate of change of the rate of change of the capacitance (e.g., using the other rate of change). For example, the device 106 and/or the device 108 may determine an average rate of change of the rate of change of the capacitance over a period of time. The device 106 and/or the device 108 compares the average rate of change of the rate of change of the capacitance to values in a table. The values in the table may be linked to different types of fluids. The device 106 and/or the device 108 may determine the value in the table that is closest to the average rate of change of the rate of change of the capacitance and determine the fluid type linked in the table to that value. The device 106 and/or the device 108 may then determine that that fluid type was absorbed by the sensor 104.

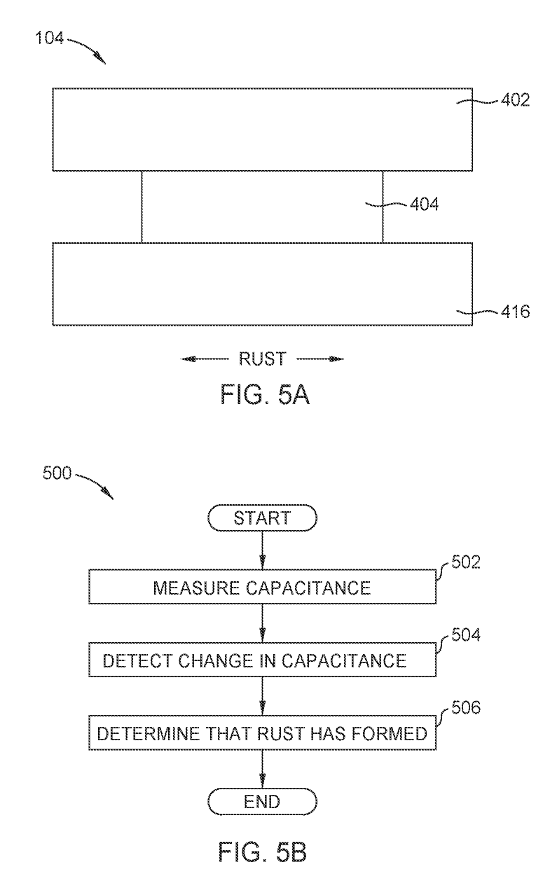

FIG. 5A illustrates an example sensor 104 in the system 100 of FIG. 1. As seen in FIG. 5A, the sensor 104 includes the layer 402, the metal layer 404, and the dielectric layer 416. In some implementations, the metal layer 404 may be formed as a metal plate (e.g., a metal plate 404). The metal layer 404 is positioned between the layer 402 and the dielectric layer 416. Generally, the sensor 104 may be positioned on the structural member 102 shown in FIG. 1 such that the dielectric layer 416 is positioned on and contacts the structural member 102. The metal layer 404, dielectric layer 416, and structural member 102 then form a capacitor.

When rust forms on the structural member 102, the rust may be positioned on the structural member 102 such that the rust is between the dielectric layer 416 and the structural member 102. As a result, the rust changes the capacitance of the capacitor. As more rust forms between the dielectric layer 416 and the structural member 102, the more the capacitance of the capacitor changes. For example, as more rust forms between the dielectric layer 416 and the structural member 102, the more the capacitance of the capacitor changes.

The device 106 and/or the device 108 may determine a difference between the capacitance of the capacitor and a baseline or original capacitance (e.g., when the sensor 104 is first installed on the structural member 102, without rust present). The magnitude of size of the difference may indicate a level of rust on the structural member 102. The device 106 and/or the device 108 may compare the difference to various thresholds to determine the level of rust. Each threshold may correspond with a level of rust. The largest threshold that the different exceeds indicates the level of rust on the structural member 102.

FIG. 5B is a flowchart of an example method 500 performed by the system 100 of FIG. 1. Different components of the system 100 perform the steps of the method 500. By performing the method 500, the system 100 determines the presence of rust.

In 502, the device 106 and/or the device 108 measure the capacitance of the capacitor formed by the sensor 104 and the structural member 102. As discussed previously, the metal layer 404, the dielectric layer 416, and the structural member 102 form a capacitor. The device 106 and/or the device 108 may measure the capacitance multiple times over a period of time.

In 504, the device 106 and/or the device 108 detect a change in the capacitance of the capacitor. For example, the device 106 and/or the device 108 may determine a difference between the measured capacitance of the capacitor and a baseline or original capacitance (e.g., when the sensor 104 was first installed or positioned on the structural member 102 without rust present). If the difference is greater than zero, then the device 106 and/or the device 108 detect a change in the capacitance.

In 506, the device 106 and/or the device 108 determine that rust has formed on the structural member 102 in response to detecting the change in the capacitance. For example, the device 106 and/or the device 108 may compare the difference between the measured capacitance and the baseline or original capacitance against various thresholds. One of the thresholds may correspond with a lowest level of rust formation. If the difference exceeds that threshold, then the device 106 and/or the device 108 may determine that rust has formed on the structural member. Other, larger thresholds may correspond with higher or larger levels of rust formation. If the difference exceeds those thresholds, then the device 106 and/or the device 108 may determine that higher or larger levels of rust have formed on the structural member 102.

In summary, the system 100 may detect the presence of a substance (e.g., fluid or rust) in an electro-mechanical system, such as an aeronautical system (e.g., an aircraft). The system 100 may include one or more sensors 104 that may be attached to structural members 102 in the electro-mechanical system (e.g., onto the surfaces of aircraft parts). When certain substances are present near the sensor 104, the capacitance of the sensor 104 may change, indicating the presence of the substance.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or described in the specification, these combinations are not intended to limit the implementations described herein. In fact, many of these features can be combined in ways not specifically recited in the claims and/or described in the specification. For example, the description includes each dependent claim in combination with every other claim in the claim set.

When “a component” or “one or more components” (or another element, such as “a processor” or “one or more processors”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items, and can be used interchangeably with “one or more.” Further, as used herein, the article “the” is intended to include one or more items referenced in connection with the article “the” and can be used interchangeably with “the one or more.” Furthermore, as used herein, the term “set” is intended to include one or more items (e.g., related items, unrelated items, or a combination of related and unrelated items,), and can be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and can be used interchangeably with “and/or,” unless explicitly stated otherwise (e.g., if used in combination with “either” or “only one of”).

What is claimed is:

1. A system comprising:
a dielectric layer comprising a moisture absorbing material;
a first metal plate positioned on the dielectric layer; and
a second metal plate positioned in the dielectric layer such that a first portion of the dielectric layer is positioned between the first metal plate and the second metal plate and such that the dielectric layer, the first metal plate, and the second metal plate form a capacitor, wherein a capacitance of the capacitor changes when the moisture absorbing material absorbs a fluid.

2. The system of claim 1, further comprising a device configured to measure, over a period of time, the capacitance of the capacitor a plurality of times.

3. The system of claim 1, further comprising a device configured to:
determine a rate of change of the capacitance of the capacitor;
determine another rate of change of the rate of change of the capacitance of the capacitor; and
determine a type of the fluid absorbed by the dielectric layer based on the other rate of change.

4. The system of claim 3, wherein the type of the fluid comprises at least one of water or oil.

5. The system of claim 1, wherein the moisture absorbing material comprises at least one of cotton or glass fiber.

6. The system claim 1, wherein the second metal plate is positioned on a second portion of the dielectric layer, and wherein the first portion of the dielectric layer is coupled to the second portion of the dielectric layer.

7. The system of claim 6, wherein the second metal plate defines a channel through which the fluid flows from the second portion of the dielectric layer to the first portion of the dielectric layer.

8. The system of claim 1, further comprising an insulation layer positioned on the first metal plate.

9. A system comprising:
a dielectric layer comprising a moisture absorbing material; and
a metal plate positioned on the dielectric layer, wherein when the dielectric layer is positioned on a structural member, the metal plate, the dielectric layer, and the structural member form a capacitor, and wherein a capacitance of the capacitor changes when the moisture absorbing material absorbs moisture.

10. The system of claim 9, further comprising a device configured to measure, over a period of time, the capacitance of the capacitor a plurality of times.

11. The system of claim 9, further comprising a device configured to:
determine a rate of change of the capacitance of the capacitor;
determine another rate of change of the rate of change of the capacitance of the capacitor; and
determine a type of fluid absorbed by the dielectric layer based on the other rate of change.

12. The system of claim 11, wherein the type of fluid comprises at least one of water or oil.

13. The system of claim 9, wherein the moisture absorbing material comprises glass fiber.

14. The system of claim 9, further comprising an insulation layer positioned on the metal plate.

15. A method comprising:
absorbing a fluid by a dielectric layer, wherein a first metal plate is positioned on the dielectric layer, and wherein a second metal plate is positioned in the dielectric layer such that a first portion of the dielectric layer is positioned between the first metal plate and the second metal plate and such that the dielectric layer, the first metal plate, and the second metal plate form a capacitor;
detecting a change in a capacitance of the capacitor caused by the dielectric layer absorbing the fluid; and
determining that the dielectric layer has absorbed the fluid based on detecting the change in the capacitance.

16. The method of claim 15, wherein detecting the change in the capacitance of the capacitor comprises measuring, over a period of time, the capacitance of the capacitor a plurality of times.

17. The method of claim 15, further comprising:
determining a rate of change of the capacitance of the capacitor;
determining another rate of change of the rate of change of the capacitance of the capacitor; and
determining a type of the fluid absorbed by the dielectric layer based on the other rate of change.

18. The method of claim 17, wherein the type of the fluid comprises at least one of water or oil.

19. The method of claim 15, wherein the dielectric layer comprises at least one of cotton or glass fiber.

20. The method claim 15, wherein the second metal plate is positioned on a second portion of the dielectric layer, and wherein the first portion of the dielectric layer is coupled to the second portion of the dielectric layer.
